(19) United States
(12) Patent Application Publication
(10) Pub. No.: US 2020/0407173 A1
(43) Pub. Date: Dec. 31, 2020

(54) Container Transport and Delivery System

(71) Applicant: 888 Brands LLC, Williamsburg, VA (US)

(72) Inventors: Daniel R. DeMartine, Toano, VA (US); John J. Douglas, Williamsburg, VA (US)

(73) Assignee: 888 Brands LLC, Williamsburg, VA (US)

(21) Appl. No.: 16/976,390

(22) PCT Filed: Apr. 12, 2019
(86) PCT No.: PCT/US19/27189

§ 371 Date: Aug. 27, 2020

Related U.S. Application Data
(60) Provisional application No. 62/656,446, filed on Apr. 12, 2018.

(51) Int. Cl. B65G 47/46; B65G 17/02; B65G 17/48; A47F 10/06

(52) U.S. Cl. CPC B65G 47/46; A47F 10/06; B65G 17/48; B65G 17/02

(57) ABSTRACT

A container transport and delivery system having at least some of an input tower having an input platform capable of vertical movement within at least a portion of the input tower and an input window providing access to the input platform; an output tower having an output platform capable of vertical movement within at least a portion of the output tower and an output window providing access to the output platform; and a transfer section disposed between the input tower and the output tower, wherein a transfer belt, disposed within the transfer section, is capable of receiving an item from the input platform and transferring the received item to the output platform, and wherein a surface of the transfer belt maintains a substantially horizontal position within the output tower.

### CROSS-REFERENCE TO RELATED APPLICATIONS

This patent application claims the benefit of U.S. Patent Application Ser. No. 62/656,446, filed Apr. 12, 2018, the entire disclosure of which is incorporated herein by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### NOTICE OF COPYRIGHTED MATERIAL

The disclosure of this patent document contains material that is subject to copyright protection. The copyright owner has no objection to the reproduction by anyone of the patent document or the patent disclosure, as it appears in the Patent and Trademark Office patent file or records, but otherwise reserves all copyright rights whatsoever. Unless otherwise noted, all trademarks and service marks identified herein are owned by the applicant.

### BACKGROUND OF THE PRESENT DISCLOSURE

### 1. Field of the Present Disclosure

The present disclosure relates generally to the field of container transport and delivery systems. More specifically, the presently disclosed systems, methods, and/or apparatuses relates to container transport and delivery systems adaptable to deliver foodstuffs or other items.

### 2. Description of Related Art

It is generally known that it is possible to transport a small, solid object over a relatively short distance by placing the object within a cylindrical container and then propelling the cylindrical container through a network of interconnected tubes by compressed air or partial vacuum. Such known systems are generally known as pneumatic tubes, capsule pipelines, or pneumatic tube transports.

Any discussion of documents, acts, materials, devices, articles, or the like, which has been included in the present specification is not to be taken as an admission that any or all of these matters form part of the prior art base or were common general knowledge in the field relevant to the present disclosure as it existed before the priority date of each claim of this application.

### BRIEF SUMMARY OF THE PRESENT DISCLOSURE

However, the typical pneumatic tube transport arrangement has various shortcomings. Pneumatic tube transports are typically restricted to transporting lightweight, solid items (such as, for example, bank deposits or receipts, paper correspondence, or the like), which are unaffected by rapid changes in orientation (i.e., vertical or upward orientation, horizontal or lateral orientation, acute or obtuse orientation, or upside down orientation). For example, a bank deposit or paper receipt is not adversely affected by being positioned in an upward orientation, sideways orientation, or downward orientation.

Unfortunately, known transport systems or arrangements do not allow for efficient transport of items that would be adversely affected by changes in orientation (such as, for example, prepared food items).

In various exemplary, non-limiting embodiments, the container transport and delivery systems of the presently disclosed systems, methods, and/or apparatuses allow for transportation and delivery of more sensitive packages or items, such as, for example, prepared food items. In certain exemplary, nonlimiting embodiments, the container transport and delivery system is designed to be utilized in a fast food or other restaurant setting and serves as a delivery system to one or more drive-through lanes.

In various exemplary, non-limiting embodiments, the container transport and delivery system, or Express Delivery System (EDS), of the present disclosure allows food item(s) and/or container(s) to be loaded into a first elevator tower or input tower, which would be located in the drive though area of the restaurant. The worker would take the customer's food item(s) and/or container(s) and place the prepared food item(s) and/or container(s) onto an input belt or input platform inside the input tower.

In certain exemplary embodiments, the food item(s) and/or container(s) would optionally be arranged such that if beverages were ordered, the beverage cups or containers would be put in the lead position inside the input tower in a drink holder. The system would utilize the restaurant's disposable beverage cup holders. Once the beverage cups were placed in the input tower, a bag or container with the remaining food item(s) and/or container(s) would be placed behind the beverage cups. The worker would then press the green start button to start the delivery process of the EDS. A safety light curtain would scan the opening of the input window and if any object was detected in the input window, the elevator system of the input tower would stop immediately and go into a fault condition. To rest the fault condition, the obstruction must be removed from the input window and the start button needs to be pressed.

Once the input window or other designated area is clear, the elevator system within the input tower would raise the input platform (with the food item(s) and/or container(s)) from the input window to an upper position, relative to a transfer section of the EDS. The height of the transfer section would be variable and would be set to the height required per restaurant.

Once the food item(s) and/or container(s) is at the level of the transfer belt of the transfer section, the food item(s) and/or container(s) would be driven out of the input tower, via a drive belt of the input platform, to the overhead or spanning transfer belt of the transfer section. The transfer belt would allow the food item(s) and/or container(s) to travel across a distance to a determined lane to deliver the food item(s) and/or container(s) to the customer.

Once the food item(s) and/or container(s) reach the end of the transfer section the food item(s) and/or container(s) would be transported onto an output platform of an output tower, to be lowered to an output window. The output platform within the output tower would lower the food item(s) and/or container(s) to the output window (typically at a level relative to a customer's car window located in the delivery lane).

Once the output tower lowers the output platform such that the food item(s) and/or container(s) are at a proper discharge height, the EDS would transport the food item(s) and/or container(s), via a belt drive of the output platform, to an output belt that would be connected to an output section of the output tower.

Once the food item(s) and/or container(s) is transported to the end of the output belt, the food item(s) and/or container(s) would wait proximate the end of the output belt until the customer removed the food item(s) and/or container(s) from the output belt.

Once the food item(s) and/or container(s) are removed from the output belt, a subsequent order could be delivered to the same output window. This process would repeat repeatedly.

In various exemplary, nonlimiting embodiments, typical transport time for the first order would be 20 seconds, staged orders would be 15 seconds or less. Also, the drink carrier could be discarded within a tray chute or collection bin portion of the output section, located proximate the customer's pick up point.

In various exemplary embodiments, the EDS would work on electrical power. Typical power required to run the system would be 15 amps 120 volts AC. Alternatively, the EDS may optionally operate utilizing one or more pneumatic air cylinders.

In various exemplary embodiments, the EDS utilizes a motorized lift system with a ball screw assembly and a smart motor positioning system in both the input tower and the output tower assemblies. The transport mechanism that would allow the food item(s) and/or container(s) order to travel from the input tower, the transfer section, and the output tower would be a belt type delivery system with smart motors. The EDS would optionally include a controller to control the entire system, non-touch screen control with basic start/stop lighted switches and emergency Estop system. Both the input tower and the output tower(s) would be equipped with light curtains to monitor the input or output openings/windows in each tower. The system would be fail safe with no pinch points. All tower and overhead conveyor would have removal covers which would allow access to the entire system for maintenance and cleaning purposes.

In various exemplary, non-limiting embodiments, the container transport and delivery systems of the presently disclosed systems, methods, and/or apparatuses comprise an input tower having an input platform disposed therein and an input window providing access to the input platform, wherein the input platform is capable of vertical movement within at least a portion of the input tower, and wherein a surface of the input platform maintains a substantially horizontal position while moving within the input tower; an output tower having an output platform disposed therein and an output window providing access to the output platform, wherein the output platform is capable of vertical movement within at least a portion of the output tower, and wherein a surface of the output platform maintains a substantially horizontal position while moving within the output tower; and a transfer section disposed between the input tower and the output tower, wherein a transfer belt is disposed within the transfer section, wherein the transfer belt is capable of receiving an item from the input platform, transferring the received from a first end portion of the transfer section to a second end portion of the transfer section, and transferring the received item from the second end portion of the transfer section to the output platform, and wherein a surface of the transfer belt maintains a substantially horizontal position within the output tower.

In various exemplary, nonlimiting embodiments, the transfer section is disposed above the input window of the input tower and above the output window of the output tower.

In various exemplary, nonlimiting embodiments, the transfer section is disposed below the input window of the input tower and below the output window of the output tower.

In various exemplary, nonlimiting embodiments, an output belt is provided proximate the output window of the output tower and wherein the output platform is capable of transferring an item from the output platform to the output belt.

In various exemplary, non-limiting embodiments, the container transport and delivery systems of the presently disclosed systems, methods, and/or apparatuses comprise an input tower having an input platform disposed therein and an input window providing access to the input platform, wherein the input platform is capable of vertical movement within at least a portion of the input tower, and wherein a surface of the input platform maintains a substantially horizontal position while moving within the input tower; an output tower having an output platform disposed therein and an output window providing access to the output platform, wherein the output platform is capable of vertical movement within at least a portion of the output tower, and wherein a surface of the output platform maintains a substantially horizontal position while moving within the output tower; and a transfer section disposed between the input tower and the output tower, wherein a transfer belt is disposed within the transfer section, wherein the transfer belt is capable of receiving an item from the input platform, transferring the received from a first end portion of the transfer section to a second end portion of the transfer section, and transferring the received item from the second end portion of the transfer section to the output platform, and wherein a surface of the transfer belt maintains a substantially horizontal position within the output tower.

In various exemplary, non-limiting embodiments, the container transport and delivery systems of the presently disclosed systems, methods, and/or apparatuses comprise an input tower having an input platform disposed therein and an input window providing access to the input platform, wherein the input platform is capable of movement within at least a portion of the input tower, and wherein a surface of the input platform maintains a desired axial or rotational position while moving within the input tower; an output tower having an output platform disposed therein and an output window providing access to the output platform, wherein the output platform is capable of movement within at least a portion of the output tower, and wherein a surface of the output platform maintains a desired axial or rotational position while moving within the output tower; and a transfer section disposed between the input tower and the output tower, wherein a transfer belt is disposed within the transfer section, wherein the transfer belt is capable of receiving an item from the input platform, transferring, via the transfer belt of the transfer section, the received item to the output platform, and wherein a surface of the transfer belt maintains a desired axial or rotational position within the output tower.

In various exemplary, non-limiting embodiments, the container transport and delivery systems of the presently disclosed systems, methods, and/or apparatuses comprise an input tower having an input platform disposed therein and an input window providing access to the input platform, wherein the input platform is capable of movement within at least a portion of the input tower, and wherein a surface of the input platform maintains a desired axial or rotational position while moving within the input tower; an output tower having an output platform disposed therein and an output window providing access to the output platform, wherein the output platform is capable of movement within at least a portion of the output tower, and wherein a surface of the output platform maintains a desired axial or rotational position while moving within the output tower; a transfer section disposed between the input tower and the output tower, wherein a transfer belt is disposed within the transfer section, wherein the transfer belt is capable of receiving an item from the input platform, transferring, via the transfer belt of the transfer section, the received item to the output platform, and wherein a surface of the transfer belt maintains a desired axial or rotational position within the output tower; at least one subsequent output tower having a subsequent output platform disposed therein and a subsequent output window providing access to the subsequent output platform, wherein the subsequent output platform of the subsequent output tower is capable of movement within at least a portion of the subsequent output tower, and wherein a surface of the subsequent output platform maintains a desired axial or rotational position while moving within the subsequent output tower; and a subsequent transfer section disposed between the output tower and the at least one subsequent output tower, wherein a subsequent transfer belt is disposed within the subsequent transfer section, wherein the subsequent transfer belt is capable of receiving an item from the output tower, transferring, via the subsequent transfer belt of the subsequent transfer section, the received item to the subsequent output platform, and wherein a surface of the subsequent transfer belt maintains a desired axial or rotational position within the subsequent output tower.

Accordingly, the presently disclosed systems, methods, and/or apparatuses separately and optionally provide a container transport and delivery system that transport items that would be adversely affected by changes in orientation.

The presently disclosed systems, methods, and/or apparatuses separately and optionally provide a container transport and delivery system that can deliver items without tipping the items from an initial position.

The presently disclosed systems, methods, and/or apparatuses separately and optionally provide a container transport and delivery system that can be easily operated by a user.

These and other aspects, features, and advantages of the presently disclosed systems, methods, and/or apparatuses are described in or are apparent from the following detailed description of the exemplary, non-limiting embodiments of the presently disclosed systems, methods, and/or apparatuses and the accompanying figures. Other aspects and features of embodiments of the presently disclosed systems, methods, and/or apparatuses will become apparent to those of ordinary skill in the art upon reviewing the following description of specific, exemplary embodiments of the presently disclosed systems, methods, and/or apparatuses in concert with the figures. While features of the presently disclosed systems, methods, and/or apparatuses may be discussed relative to certain embodiments and figures, all embodiments of the presently disclosed systems, methods, and/or apparatuses can include one or more of the features discussed herein. Further, while one or more embodiments may be discussed as having certain advantageous features, one or more of such features may also be used with the various embodiments of the systems, methods, and/or apparatuses discussed herein. In similar fashion, while exemplary embodiments may be discussed below as device, system, or method embodiments, it is to be understood that such exemplary embodiments can be implemented in various devices, systems, and methods of the presently disclosed systems, methods, and/or apparatuses.

Any benefits, advantages, or solutions to problems that are described herein with regard to specific embodiments are not intended to be construed as a critical, required, or essential feature(s) or element(s) of the presently disclosed systems, methods, and/or apparatuses or the claims.

### BRIEF DESCRIPTION OF THE SEVERAL VIEWS OF THE DRAWINGS

As required, detailed exemplary embodiments of the presently disclosed systems, methods, and/or apparatuses are disclosed herein; however, it is to be understood that the disclosed embodiments are merely exemplary of the presently disclosed systems, methods, and/or apparatuses that may be embodied in various and alternative forms, within the scope of the presently disclosed systems, methods, and/or apparatuses. The figures are not necessarily to scale; some features may be exaggerated or minimized to illustrate details of particular components. Therefore, specific structural and functional details disclosed herein are not to be interpreted as limiting, but merely as a basis for the claims and as a representative basis for teaching one skilled in the art to employ the presently disclosed systems, methods, and/or apparatuses.

The exemplary embodiments of the presently disclosed systems, methods, and/or apparatuses will be described in detail, with reference to the following figures, wherein like reference numerals refer to like parts throughout the several views, and wherein:

FIG. 1 illustrates a perspective view of an exemplary embodiment of a container transport and delivery system, according to the presently disclosed systems, methods, and/or apparatuses;

FIG. 2 illustrates a perspective view of an exemplary embodiment of a container transport and delivery system, according to the presently disclosed systems, methods, and/or apparatuses;

FIG. 3 illustrates a side view of an exemplary embodiment of a container transport and delivery system, according to the presently disclosed systems, methods, and/or apparatuses;

FIG. 4 illustrates a more detailed view of a portion of an output tower of an exemplary embodiment of a container transport and delivery system, according to the presently disclosed systems, methods, and/or apparatuses;

FIG. 5A illustrates a partial cutaway, top view of an exemplary embodiment of a container transport and delivery system, according to the presently disclosed systems, methods, and/or apparatuses;

FIG. 5B illustrates a partial cutaway, left side view of an exemplary embodiment of a container transport and delivery system, according to the presently disclosed systems, methods, and/or apparatuses;

FIG. 5C illustrates a partial cutaway, front view of an exemplary embodiment of a container transport and delivery system, according to the presently disclosed systems, methods, and/or apparatuses;

FIG. 6A illustrates a partial cutaway, top view of an exemplary embodiment of a container transport and delivery system, according to the presently disclosed systems, methods, and/or apparatuses;

FIG. 6B illustrates a partial cutaway, left side view of an exemplary embodiment of a container transport and delivery system, according to the presently disclosed systems, methods, and/or apparatuses;

FIG. 6C illustrates a partial cutaway, front view of an exemplary embodiment of a container transport and delivery system, according to the presently disclosed systems, methods, and/or apparatuses;

FIG. 7A illustrates a partial cutaway, top view of an exemplary embodiment of a container transport and delivery system, according to the presently disclosed systems, methods, and/or apparatuses;

FIG. 7B illustrates a partial cutaway, left side view of an exemplary embodiment of a container transport and delivery system, according to the presently disclosed systems, methods, and/or apparatuses;

FIG. 7C illustrates a partial cutaway, front view of an exemplary embodiment of a container transport and delivery system, according to the presently disclosed systems, methods, and/or apparatuses;

FIG. 8A illustrates a partial cutaway, top view of an exemplary embodiment of a container transport and delivery system, according to the presently disclosed systems, methods, and/or apparatuses;

FIG. 8B illustrates a partial cutaway, left side view of an exemplary embodiment of a container transport and delivery system, according to the presently disclosed systems, methods, and/or apparatuses;

FIG. 8C illustrates a partial cutaway, front view of an exemplary embodiment of a container transport and delivery system, according to the presently disclosed systems, methods, and/or apparatuses;

FIG. 9 illustrates a top view of an exemplary embodiment of a container transport and delivery system, according to the presently disclosed systems, methods, and/or apparatuses;

FIG. 10 illustrates a front view of an exemplary embodiment of a container transport and delivery system, according to the presently disclosed systems, methods, and/or apparatuses;

FIG. 11 illustrates a left side view of an exemplary embodiment of a container transport and delivery system, according to the presently disclosed systems, methods, and/or apparatuses;

FIG. 12 illustrates a right side view of an exemplary embodiment of a container transport and delivery system, according to the presently disclosed systems, methods, and/or apparatuses;

FIG. 13A illustrates a partial cutaway, top view of an exemplary embodiment of a container transport and delivery system, according to the presently disclosed systems, methods, and/or apparatuses;

FIG. 13B illustrates a partial cutaway, left side view of an exemplary embodiment of a container transport and delivery system, according to the presently disclosed systems, methods, and/or apparatuses;

FIG. 13C illustrates a partial cutaway, front view of an exemplary embodiment of a container transport and delivery system, according to the presently disclosed systems, methods, and/or apparatuses;

FIG. 14A illustrates a partial cutaway, top view of an exemplary embodiment of a container transport and delivery system, according to the presently disclosed systems, methods, and/or apparatuses;

FIG. 14B illustrates a partial cutaway, left side view of an exemplary embodiment of a container transport and delivery system, according to the presently disclosed systems, methods, and/or apparatuses;

FIG. 14C illustrates a partial cutaway, front view of an exemplary embodiment of a container transport and delivery system, according to the presently disclosed systems, methods, and/or apparatuses;

FIG. 15A illustrates a partial cutaway, top view of an exemplary embodiment of a container transport and delivery system, according to the presently disclosed systems, methods, and/or apparatuses;

FIG. 15B illustrates a partial cutaway, left side view of an exemplary embodiment of a container transport and delivery system, according to the presently disclosed systems, methods, and/or apparatuses;

FIG. 15C illustrates a partial cutaway, front view of an exemplary embodiment of a container transport and delivery system, according to the presently disclosed systems, methods, and/or apparatuses;

FIG. 16 illustrates a top view of an exemplary embodiment of a container transport and delivery system, according to the presently disclosed systems, methods, and/or apparatuses;

FIG. 17 illustrates a front view of an exemplary embodiment of a container transport and delivery system, according to the presently disclosed systems, methods, and/or apparatuses; and

FIG. 18 illustrates a right side view of an exemplary embodiment of a container transport and delivery system, according to the presently disclosed systems, methods, and/or apparatuses.

### DETAILED DESCRIPTION OF EXEMPLARY EMBODIMENTS OF THE PRESENT DISCLOSURE

For simplicity and clarification, the design factors and operating principles of the container transport and delivery system according to the presently disclosed systems, methods, and/or apparatuses are explained with reference to various exemplary embodiments of a container transport and delivery system according to the presently disclosed systems, methods, and/or apparatuses. The basic explanation of the design factors and operating principles of the container transport and delivery system is applicable for the understanding, design, and operation of the container transport and delivery system of the presently disclosed systems, methods, and/or apparatuses. It should be appreciated that the container transport and delivery system can be adapted to many applications where a transport and delivery system can be used.

As used herein, the word “may” is meant to convey a permissive sense (i.e., meaning “having the potential to”), rather than a mandatory sense (i.e., meaning “must”). Unless stated otherwise, terms such as “first” and “second” are used to arbitrarily distinguish between the exemplary embodiments and/or elements such terms describe. Thus, these terms are not necessarily intended to indicate temporal or other prioritization of such exemplary embodiments and/or elements.

The term “coupled”, as used herein, is defined as connected, although not necessarily directly, and not necessarily mechanically. The terms “a” and “an” are defined as one or more unless stated otherwise.

Throughout this application, the terms “comprise” (and any form of comprise, such as “comprises” and “comprising”), “have” (and any form of have, such as “has” and “having”), “include”, (and any form of include, such as “includes” and “including”) and “contain” (and any form of contain, such as “contains” and “containing”) are used as open-ended linking verbs. It will be understood that these terms are meant to imply the inclusion of a stated element, integer, step, or group of elements, integers, or steps, but not the exclusion of any other element, integer, step, or group of elements, integers, or steps. As a result, a system, method, or apparatus that “comprises”, “has”, “includes”, or “contains” one or more elements possesses those one or more elements but is not limited to possessing only those one or more elements. Similarly, a method or process that “comprises”, “has”, “includes” or “contains” one or more operations possesses those one or more operations but is not limited to possessing only those one or more operations.

It should also be appreciated that the terms “container transport”, “delivery system”, “food item(s)”, and “container(s)” are used for basic explanation and understanding of the operation of the systems, methods, and apparatuses of the presently disclosed systems, methods, and/or apparatuses. Therefore, the terms “container transport”, “delivery system”, “food item(s)”, and “container(s)” are not to be construed as limiting the systems, methods, and apparatuses of the presently disclosed systems, methods, and/or apparatuses. Thus, the terms “food item(s)”, and “container(s)” are to be understood to broadly include any packaged or unpackaged item or object or any container for a package or unpackaged item or object.

For simplicity and clarification, the container transport and delivery system of the presently disclosed systems, methods, and/or apparatuses will be described as being used in conjunction with food item(s) and/or container(s). However, it should be appreciated that these are merely exemplary embodiments of the container transport and delivery system and are not to be construed as limiting the presently disclosed systems, methods, and/or apparatuses. Thus, the container transport and delivery system of the presently disclosed systems, methods, and/or apparatuses may be utilized in conjunction with any item or object.

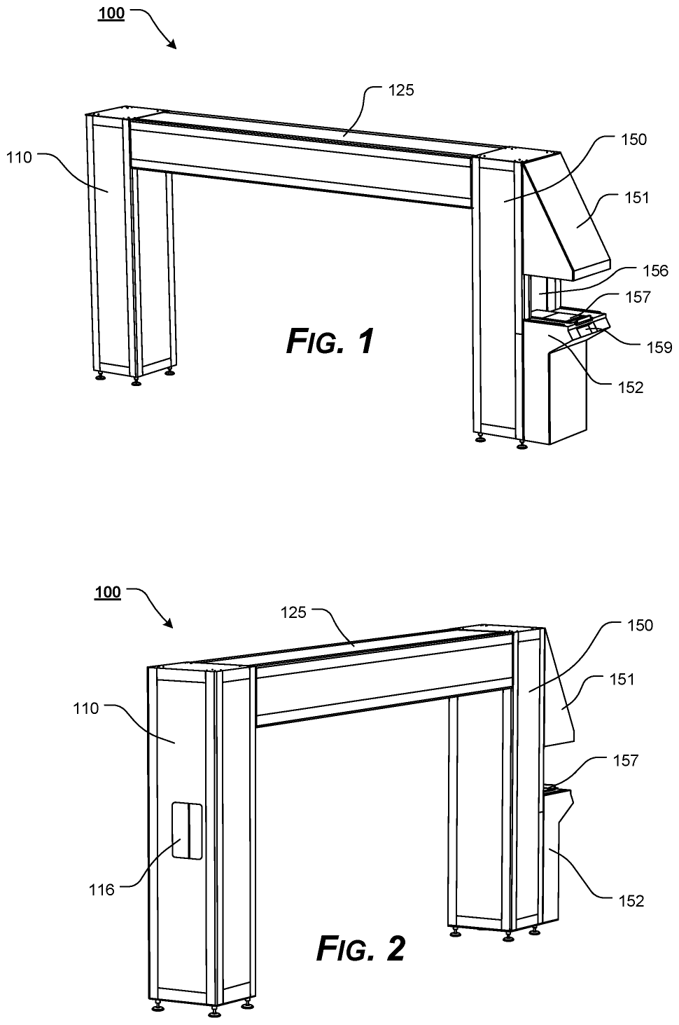

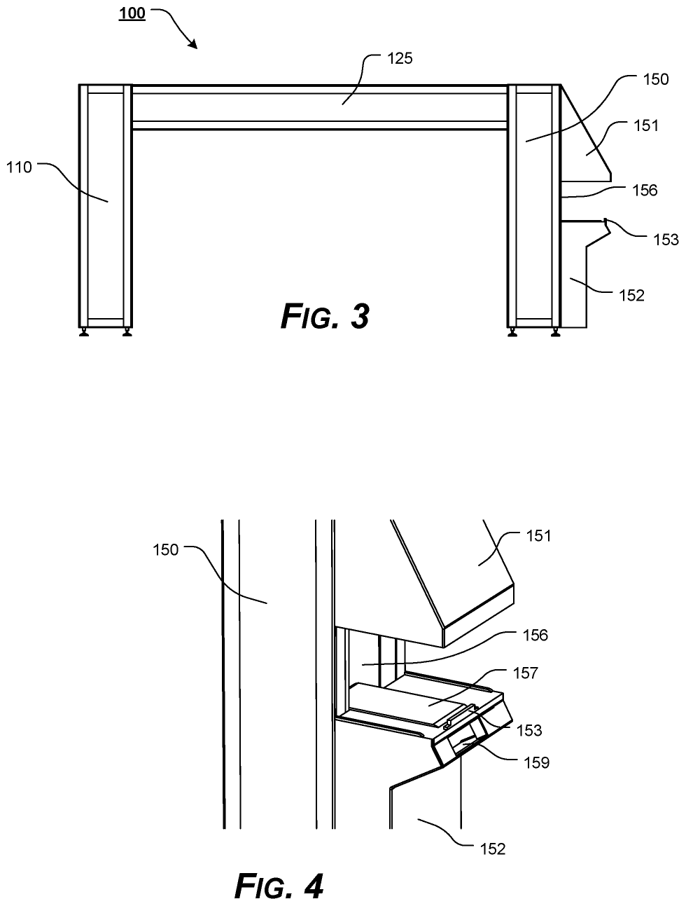

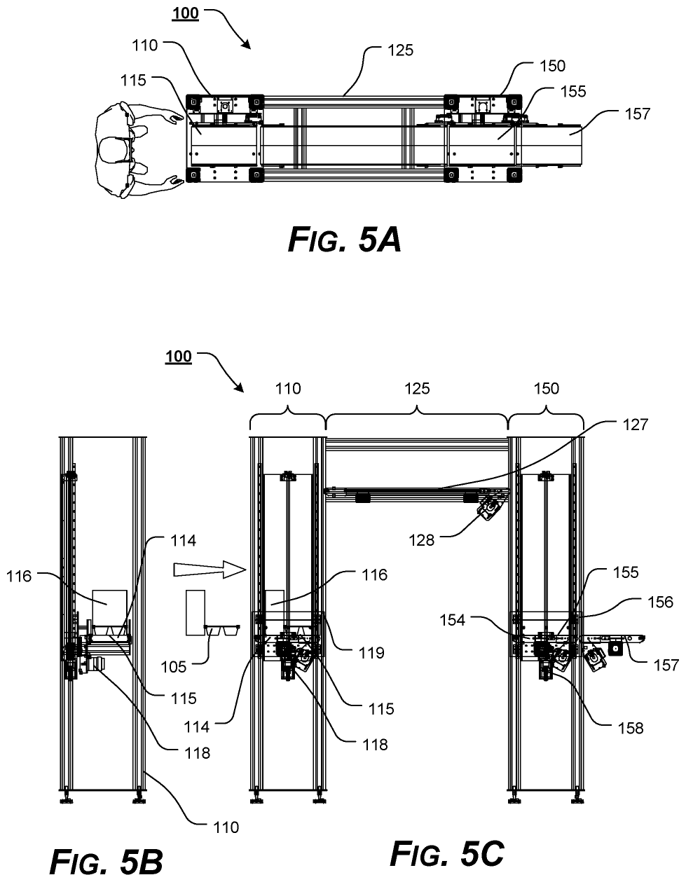

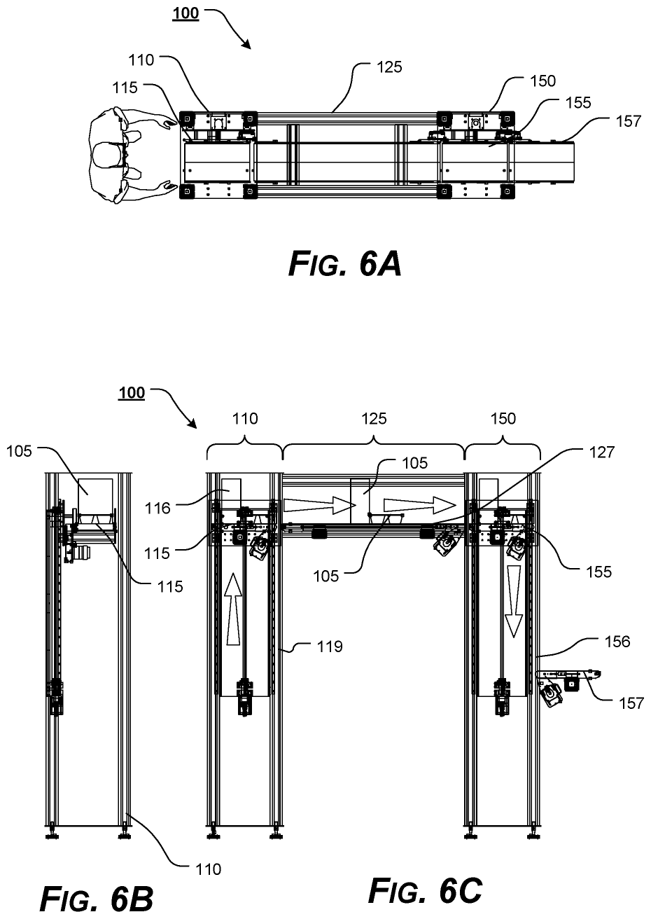

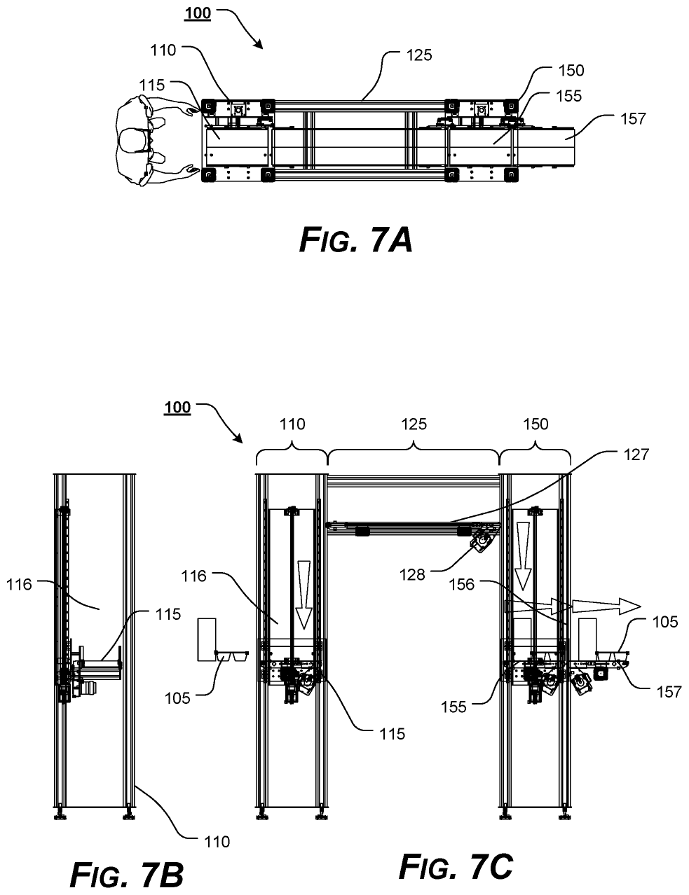

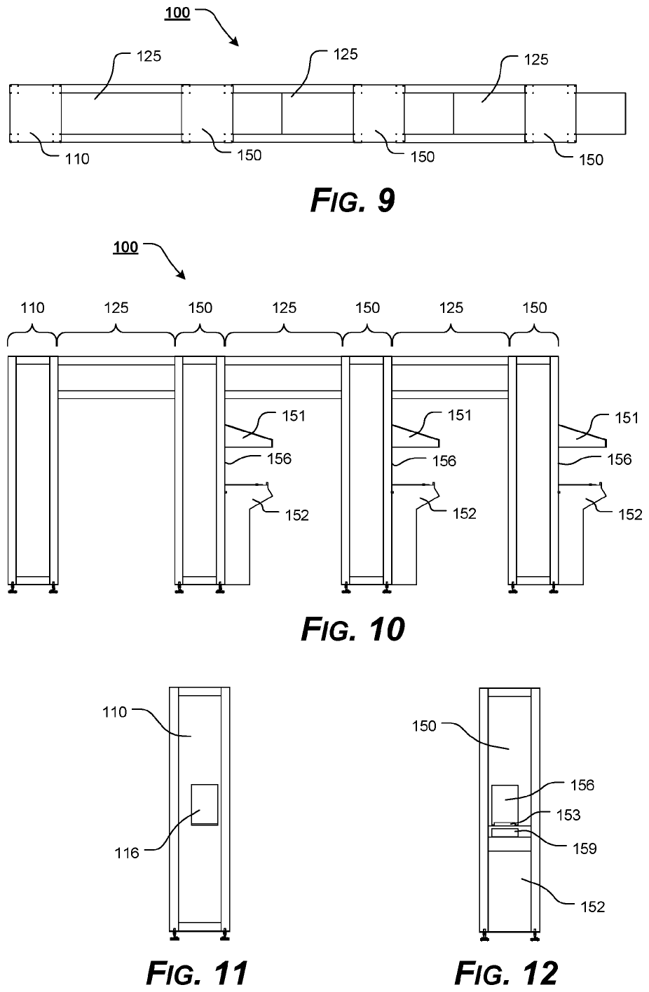

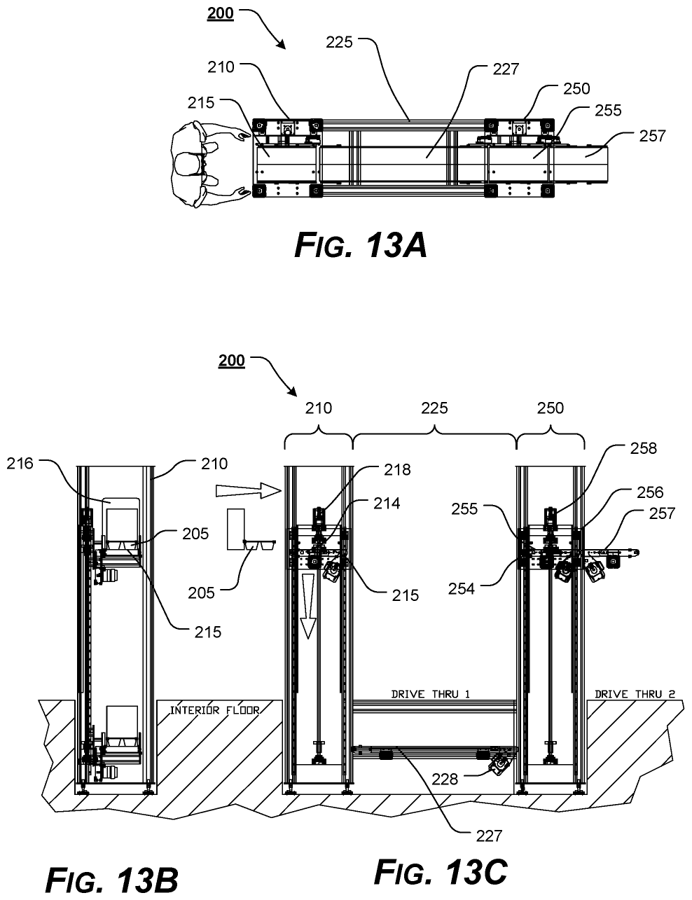

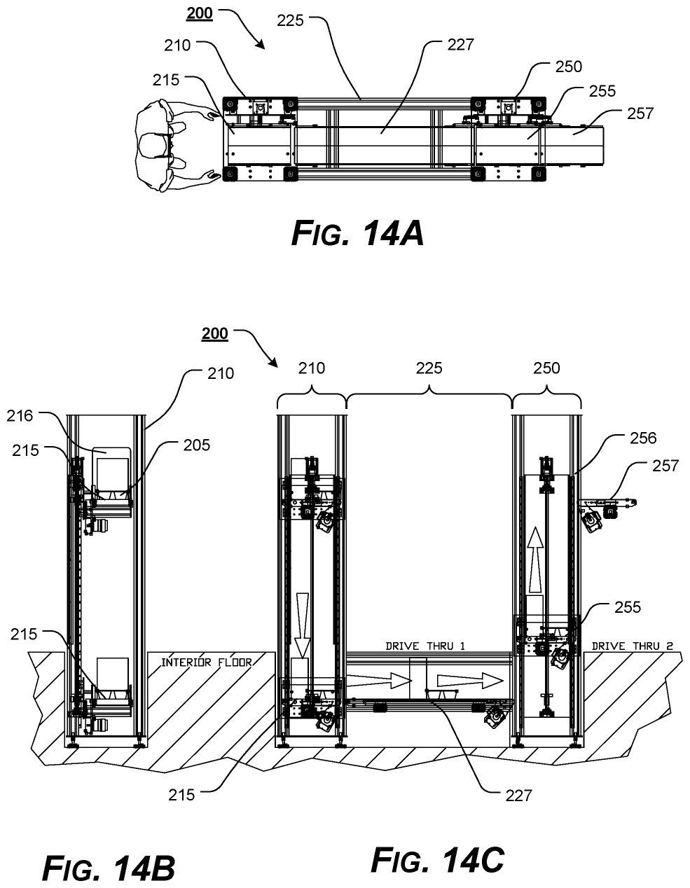

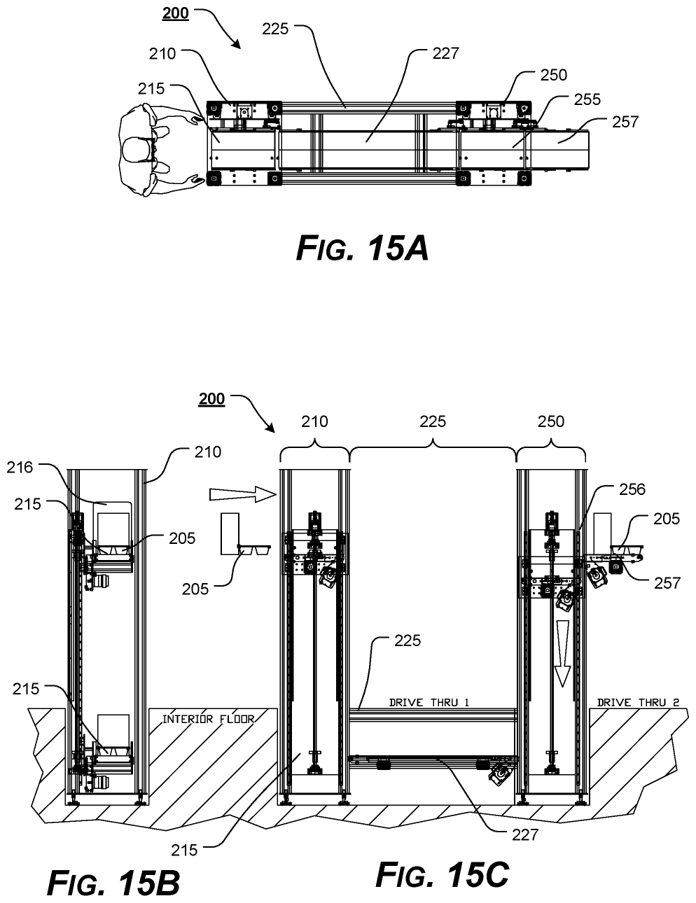

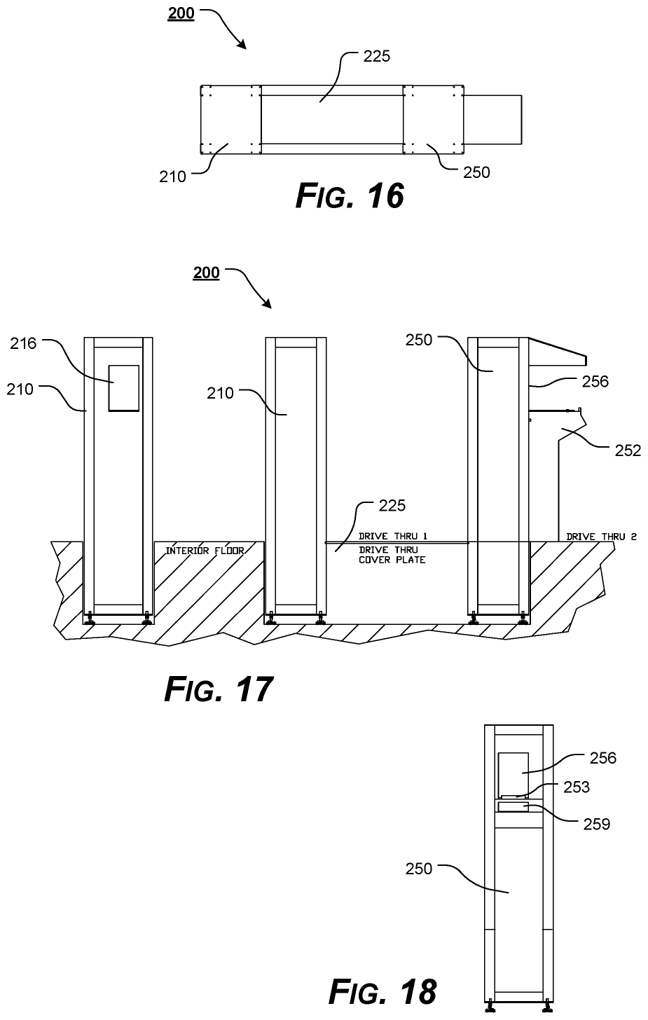

Turning now to the appended drawing figures, FIGS. 1-12 illustrate certain elements and/or aspects of an exemplary embodiment of a container transport and delivery system 100, according to the presently disclosed systems, methods, and/or apparatuses, while FIGS. 13-18 illustrate certain elements and/or aspects of an alternative, exemplary embodiment of a container transport and delivery system 200, according to the presently disclosed systems, methods, and/or apparatuses.

In illustrative, non-limiting embodiment(s) of the presently disclosed systems, methods, and/or apparatuses, as illustrated in FIGS. 1-12, the container transport and delivery system 100 comprises an input tower 110, an output tower 150, and a transfer section 125 disposed between the input tower 110 and the output tower 150.

The input tower 110 extends substantially vertically from a bottom portion to a top portion. An interior of the input tower 110 is formed so as to include an at least partial internal cavity that allows an input platform 115 to be disposed therein and to move vertically within at least a portion of the input tower 110. An input window 116 is formed in the input tower 110 to provide access to the internal cavity of the input tower 110 and access to the input platform 115.

The input tower 110 includes a motorized lift assembly 118 that is operable to move the input platform 115 between at least two determined locations within the input platform 115. The input platform 115 is typically operated to move between a first location that allows access to the input platform 115 from the input window 116 and a second location that positions a surface of the input platform substantially parallel to a surface of the transfer belt 127 of the transfer section 125. In various exemplary, nonlimiting embodiments, the input tower 110 utilizes a belt/chain transfer section 125 to move the input platform 115 vertically, within the input tower 110.

As the input platform 115 moves vertically, within at least a portion of the input tower 110, an upper surface of the input platform 115 maintains a desired axial or rotational position as the input platform 115 moves within the input tower 110. In various exemplary embodiments, an upper surface of the input platform maintains a substantially horizontal position within the input tower 110. In this manner, food or other items based upon the input platform 115 can be moved within the input tower 110, while being maintained at a desired orientation on a substantially stable platform, so as not to be tipped or spilled. Typically, the input platform 115 moves vertically between the input window 116 and an upper portion of the input tower 110. When the input platform 115 is proximate the input window 116, the upper surface of the input platform 115 is substantially coplanar with an upper surface of the transfer belt 127 of the transfer section 125.

Thus, the input tower 110 is capable of receiving a container 105 through the input window 116 to be placed upon the input platform 115. The input platform 115 can then be moved upward, from a position proximate the input window 116 to a position proximate the transfer belt 127 of the transfer section 125. The input platform 115 is typically moved to a position proximate the transfer belt 127 such that the container 105 placed upon the input platform 115 can be transitioned to the transfer belt 127.

It should be appreciated that in various exemplary embodiments, an optional pass-through aperture 119 is formed substantially opposite the input window 116. In this manner, containers 105 can be passed through the input window 116, through the input tower 110, and through the optional pass-through aperture 119, bypassing the input platform 115 of the input tower 110 for direct delivery through the input tower 110.

In various exemplary embodiments, the input platform 115 includes an input platform drive belt 114 that is capable of moving to receive containers 105 onto the input platform 115 or moving to transfer containers 105 from the input platform 115.

One or more light curtains or other sensors may optionally be positioned proximate the input window 116 to ensure that the input window 116 is clear of objects or obstructions before the input platform 115 is able to move within the input tower 110.

The output tower 150 extends substantially vertically from a bottom portion to a top portion. An interior of the output tower 150 is formed so as to include an at least partial internal cavity that allows an output platform 155 to be disposed therein and to move vertically within at least a portion of the output tower 150. An output window 156 is formed in the output tower 150 to provide access to the output platform 155.

The output tower 150 includes a motorized lift assembly 158 that is operable to move the output platform 155 between at least two determined locations within the output platform 155. The output platform 155 is typically operated to move between a first location that allows access to the output platform 155 from the output window 156 and a second location that positions a surface of the input platform substantially parallel to a surface of the transfer belt 127 of the transfer section 125.

In various exemplary, nonlimiting embodiments, the output tower 150 utilizes a belt/chain transfer section 125 to move the output platform 155 vertically, within the output tower 150.

As the output platform 155 moves vertically, within at least a portion of the output tower 150, an upper surface of the output platform 155 maintains a desired axial or rotational position as the output platform 155 moves within the output tower 150. In various exemplary embodiments, an upper surface of the input platform maintains a substantially horizontal position within the output tower 150. In this manner, food or other items can be moved within the output tower 150, while being maintained at a desired orientation on a substantially stable platform, so as not to be tipped or spilled. Typically, the output platform 155 moves vertically between an upper portion of the output tower 150 and the output window 156. When the output platform 155 is positioned proximate the output window 156, the upper surface of the output platform 155 is substantially coplanar with an upper surface of the output belt 157 of the output tower 150.

As illustrated, the transfer section 125 joins the input section 110 and the output section 150. The transfer section 125 is positioned such that when the input platform 115 is in an upper position, a surface of the input platform 115 is substantially parallel to a surface of the transfer belt 127 of the transfer section 125. Similarly, when the output platform 155 is in an upper position, a surface of the output platform 155 is substantially parallel to a surface of the transfer belt 127 of the transfer section 125. In various exemplary embodiments, a motorized transfer belt assembly 128 operates to rotationally move the transfer belt 127. In this manner, containers 105 can be transferred, via the transfer belt 127, from an area proximate the input section 110 to an area proximate the output section 150.

Thus, the output tower 150 is capable of receiving a container 105 that is transferred from the transfer belt 127 of the transfer section 125 to an output platform 155. The output platform 155 can then be moved downward, from a position proximate the transfer belt 127 of the transfer section 125 to a position proximate the output window 156. The output platform 155 is typically moved to a position proximate the output window 156 that the container 105 placed upon the output platform 155 can be transitioned through the output window 156, to the output belt 157. Once the container 105 is received on the output belt 157, the output belt 157 can move to transition the container 105 toward an output stop 153 of the output tower 150. The output belt 157 allows food items to be buffered so customers can pick up the food items from the output belt 157. In various exemplary embodiments, the output stop 153 is a portion of material that extends proximate the end of the path of the output belt 157 so that containers 105 will be maintained in a position relative to the output belt 157 and will not be urged off of the output tower 150 of the output tower 150.

In various exemplary embodiments, the output platform 155 includes an output platform drive belt 154 that is capable of moving to receive containers 105 on to the output platform 155 or moving to transfer containers 105 from the output platform 155.

In certain embodiments, an output hood 151 is provided over at least a portion of the output belt 157, so as to provide shielding of the output belt 157 (and any items placed upon the output belt 157) from the elements.

A tray chute 159 or collection bin portion of the output extension portion 152 may optionally be provided, proximate the customer's pick up point. If included, the tray chute 159 allows unwanted delivery trays or other items to be discarded.

The transfer section 125 is disposed between the input tower 110 and the output tower 150. The transfer section 125 extends substantially horizontally from a first end portion to a second end portion. An interior of the transfer section 125 is formed so as to allow transfer belt 127 to be disposed therein and to move substantially horizontally within at least a portion of the transfer section 125.

In various exemplary embodiments, the transfer belt 127 is capable of receiving a container 105 from the input platform 115, transferring the received container 105 from a first end portion of the transfer section 125 to a second end portion of the transfer section 125, and transferring the received container 105 from the second end portion of the transfer section 125 to the output platform 155. During the transfer from the first end portion to the second end portion, a surface of the transfer belt 127 maintains a substantially horizontal position within the transfer section 125.

It should be appreciated that the container 105 may be a container, package, bag, box, or other device or element used to hold one or more items. It should also be appreciated that the container 105 may comprise one or more individual items, whether packaged or unpackaged.

The transfer section 125 has a motorized transfer belt 127 used to move containers 105 between the first end portion and the second end portion. In various exemplary, nonlimiting embodiments, the transfer section 125 utilizes a belt/chain motorized transfer belt assembly 128 to move the transfer belt 127, within the transfer section 125. In certain exemplary embodiments, the transfer section 125 is a belt/chain driven section and is used transfer food or other items above a car in a drive-through lane.

One or more light curtains or other sensors may optionally be positioned proximate the output window 156 to be sure that the output window 156 is clear of objects or obstructions before the output platform 155 is able to move within the output tower 150.

In various exemplary, nonlimiting embodiments, input or on/off switches may optionally be utilized to actuate the input platform 115, the transfer belt 127, the output platform 155, and/or the output belt 157. Alternatively, a main control system (such as a PC-based or PLC based control system), can be utilized to control he input platform 115, the transfer belt 127, the output platform 155, and/or the output belt 157. The various switches or controls can be manual switches or controls or touchscreen display based switches or controls.

By way of example and not limitation, and utilizing the container transport and delivery system 100 as illustrated FIGS. 1-7C, during use of the container transport and delivery system 100 in a fast food restaurant environment, a customer places an order and the ordered items are prepared and placed in an appropriate container 105.

The container 105 (or the individual ordered items) is then placed through the input window 116 and onto the input platform 115. The container transport and delivery system 100 is actuated (either manually or by computer control) and the input platform 115 is elevated, through the input tower 110, until a surface of the input platform 115 is substantially parallel to a surface of the transfer belt 127. Once appropriately aligned, the input platform belt 114 of the input platform 115 is actuated and the belt drive of the transfer belt 127 is actuated to transfer the container 105 from the input platform 115 to the transfer belt 127.

The transfer belt 127 is actuated so as to receive the container 105 from the input platform 115 and transfer the container 105 from the first end portion of the transfer section 125 (proximate the input section 110) to the second end portion of the transfer section 125 (proximate the output section 150). As the container 105 reaches the second end of the transfer belt 127, an output platform 155, is or has been elevated, through the output tower 150, so that a surface of the output platform 155 is substantially parallel to the surface of the transfer belt 127. The surface of the transfer belt 127 receives the container 105 and the output platform belt 154 is operated to position the container 105 atop the output platform 155.

Once the container 105 is appropriately positioned atop the output platform 155, the output platform 155 is lowered, through the output tower 150, so that the surface of the output platform 155 is substantially parallel to a surface of the output belt 157. Once appropriately aligned, the output platform belt 154 of the output platform 155 is actuated and the output belt 157 is actuated to transfer the container 105 from the output platform 155, through the output window 156, to the output belt 157.

Once the container 105 is received atop the output belt 157, the output belt 157 continues to be actuated to transfer the container 105 toward the customer. When the container 105 is appropriately positioned relative to the customer, the customer is able to retrieve the container 105 from the output belt 157. If the customer desires, any portion of the container 105 or other containers 105 can be discarded through the tray chute 159, if included.

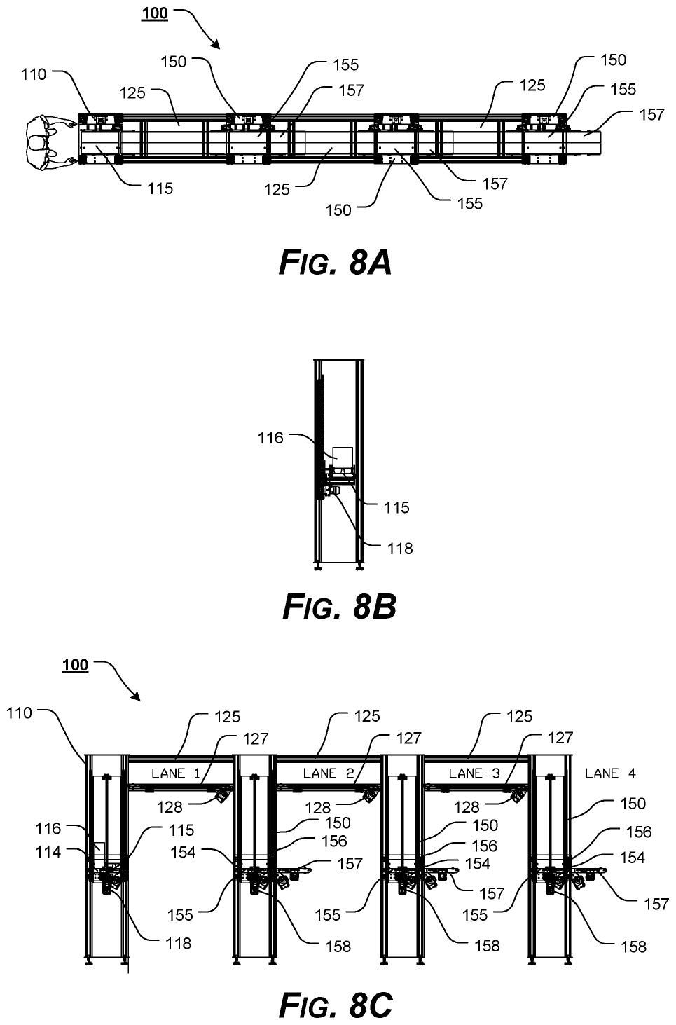

As illustrated FIGS. 8A-12, the number of output towers 150 can be varied and is optional based upon the number of pickup locations or drive-through locations to be serviced. The output section 150 closest to the input section 110 is joined by a transfer section 125. Each subsequent output section 150 is joined to the preceding output section 150, via a transfer section 125. Each subsequent transfer section 125 includes or more transfer belts 127 that can be utilized to transfer containers 105 from the input tower 110 to a determined one of a plurality of subsequent output towers 150.

FIGS. 13-18 illustrate an exemplary embodiment of the container transport and delivery system 200 of the present disclosure. However, as illustrated FIGS. 13-18, the container transport and delivery system 200 comprises at least some of an input section 210, and input platform belt 214, an input platform 215, an input window 216, a motorized lift assembly 218, an optional pass-through aperture 219, a transfer section 225, a transfer belt 227, a motorized transfer belt assembly 228, an output section 250, an output hood 251, an output extension portion 252, an output stop 253, an output platform belt 254, an output platform 255, an output window 256, an output belt 257, a motorized lift assembly 258, and a tray chute 259, and is constructed to be utilized in conjunction with one or more containers 205.

It should be appreciated that each of these elements corresponds to and operates similarly to the input section 110, the input platform belt 114, the input platform 115, the input window 116, the motorized lift assembly 118, the optional pass-through aperture 119, the transfer section 125, the transfer belt 127, the motorized transfer belt assembly 128, the output section 150, the output hood 151, the output extension portion 152, the output stop 153, the output platform belt 154, the output platform 155, the output window 156, the output belt 157, the motorized lift assembly 158, the tray chute 159, and the container 105, as discussed herein, with respect to the container transport and delivery system 100.

However, as illustrated in FIGS. 13-18, the transfer section 125 is disposed below the input window 116 of the input tower 110 and below the output window 156 of the output tower 150. During operation of the container transport and delivery system 200, the input platform 215 is operated to move downward toward the transfer belt 227 to transfer a container 205 from the input platform 215 to the transfer belt 227. The output platform 255 is operated to move upward toward the output window 256 to transfer a container 205 from the transfer belt 227 to the output belt 257.

Thus, it should be appreciated that the transfer section 125 may be disposed above the input window 116 of the input tower 110 and above the output window 156 of the output tower 150, as illustrated FIGS. 1-12, so as to transfer containers 105 above and over a walkway or drive-through. Alternatively, the transfer section 125 may be disposed below the input window 116 of the input tower 110 and below the output window 156 of the output tower 150, as illustrated FIGS. 13-18, so as to transfer containers 105 below or under a walkway or pavement of a drive-through.

While the presently disclosed systems, methods, and/or apparatuses has been described in conjunction with the exemplary embodiments outlined above, the foregoing description of exemplary embodiments of the presently disclosed systems, methods, and/or apparatuses, as set forth above, are intended to be illustrative, not limiting and the fundamental disclosed systems, methods, and/or apparatuses should not be considered to be necessarily so constrained. It is evident that the presently disclosed systems, methods, and/or apparatuses is not limited to the particular variation set forth and many alternatives, adaptations modifications, and/or variations will be apparent to those skilled in the art.

It is to be understood that the phraseology of terminology employed herein is for the purpose of description and not of limitation. Unless defined otherwise, all technical and scientific terms used herein have the same meaning as commonly understood by one of ordinary skill in the art to which the presently disclosed systems, methods, and/or apparatuses belongs.

In addition, it is contemplated that any optional feature of the inventive variations described herein may be set forth and claimed independently, or in combination with any one or more of the features described herein.

Accordingly, the foregoing description of exemplary embodiments will reveal the general nature of the presently disclosed systems, methods, and/or apparatuses, such that others may, by applying current knowledge, change, vary, modify, and/or adapt these exemplary, non-limiting embodiments for various applications without departing from the spirit and scope of the presently disclosed systems, methods, and/or apparatuses and elements or methods similar or equivalent to those described herein can be used in practicing the presently disclosed systems, methods, and/or apparatuses. Any and all such changes, variations, modifications, and/or adaptations should and are intended to be comprehended within the meaning and range of equivalents of the disclosed exemplary embodiments and may be substituted without departing from the true spirit and scope of the presently disclosed systems, methods, and/or apparatuses.

Also, it is noted that as used herein and in the appended claims, the singular forms “a”, “and”, “said”, and “the” include plural referents unless the context clearly dictates otherwise. Conversely, it is contemplated that the claims may be so-drafted to require singular elements or exclude any optional element indicated to be so here in the text or drawings. This statement is intended to serve as antecedent basis for use of such exclusive terminology as “solely”, “only”, and the like in connection with the recitation of claim elements or the use of a “negative” claim limitation(s).

What is claimed is:

1. A container transport and delivery system, comprising:
an input tower having an input platform disposed therein and an input window providing access to said input platform, wherein said input platform is capable of vertical movement within at least a portion of said input tower, and wherein a surface of said input platform maintains a substantially horizontal position while moving within said input tower;
an output tower having an output platform disposed therein and an output window providing access to said output platform, wherein said output platform is capable of vertical movement within at least a portion of said output tower, and wherein a surface of said output platform maintains a substantially horizontal position while moving within said output tower; and
a transfer section disposed between said input tower and said output tower, wherein a transfer belt is disposed within said transfer section, wherein said transfer belt is capable of receiving an item from said input platform, transferring said received from a first end portion of said transfer section to a second end portion of said transfer section, and transferring said received item from said second end portion of said transfer section to said output platform, and wherein a surface of said transfer belt maintains a substantially horizontal position within said output tower.

2. The container transport and delivery system of claim 1, wherein said input tower extends substantially vertically.

3. The container transport and delivery system of claim 1, wherein said output tower extends substantially vertically.

4. The container transport and delivery system of claim 1, wherein said transfer section extends substantially horizontally.

5. The container transport and delivery system of claim 1, wherein said transfer section is disposed above said input window of said input tower and above said output window of said output tower.

6. The container transport and delivery system of claim 1, wherein said transfer section is disposed below said input window of said input tower and below said output window of said output tower.

7. The container transport and delivery system of claim 1, further comprising an output belt disposed proximate said output window of said output tower and wherein said output platform is capable of transferring an item from said output platform to said output belt.

8. A container transport and delivery system, comprising:
an input tower having an input platform disposed therein and an input window providing access to said input platform, wherein said input platform is capable of movement within at least a portion of said input tower, and wherein a surface of said input platform maintains a desired axial or rotational position while moving within said input tower;
an output tower having an output platform disposed therein and an output window providing access to said output platform, wherein said output platform is capable of movement within at least a portion of said output tower, and wherein a surface of said output platform maintains a desired axial or rotational position while moving within said output tower; and
a transfer section disposed between said input tower and said output tower, wherein a transfer belt is disposed within said transfer section, wherein said transfer belt is capable of receiving an item from said input platform, transferring, via said transfer belt of said transfer section, said received item to said output platform, and wherein a surface of said transfer belt maintains a desired axial or rotational position within said output tower.

9. The container transport and delivery system of claim 8, wherein said input tower extends substantially vertically.

10. The container transport and delivery system of claim 8, wherein said output tower extends substantially vertically.

11. The container transport and delivery system of claim 8, wherein said transfer section extends substantially horizontally.

12. The container transport and delivery system of claim 8, wherein said transfer section is disposed above said input window of said input tower and above said output window of said output tower.

13. The container transport and delivery system of claim 8, wherein said transfer section is disposed below said input window of said input tower and below said output window of said output tower.

14. The container transport and delivery system of claim 8, further comprising an output belt disposed proximate said output window of said output tower and wherein said output platform is capable of transferring an item from said output platform to said output belt.

15. A container transport and delivery system, comprising:
an input tower having an input platform disposed therein and an input window providing access to said input platform, wherein said input platform is capable of movement within at least a portion of said input tower, and wherein a surface of said input platform maintains a desired axial or rotational position while moving within said input tower;
an output tower having an output platform disposed therein and an output window providing access to said output platform, wherein said output platform is capable of movement within at least a portion of said output tower, and wherein a surface of said output platform maintains a desired axial or rotational position while moving within said output tower;
a transfer section disposed between said input tower and said output tower, wherein a transfer belt is disposed within said transfer section, wherein said transfer belt is capable of receiving an item from said input platform, transferring, via said transfer belt of said transfer section, said received item to said output platform, and wherein a surface of said transfer belt maintains a desired axial or rotational position within said output tower;
at least one subsequent output tower having a subsequent output platform disposed therein and a subsequent output window providing access to said subsequent output platform, wherein said subsequent output platform of said subsequent output tower is capable of movement within at least a portion of said subsequent output tower, and wherein a surface of said subsequent output platform maintains a desired axial or rotational position while moving within said subsequent output tower; and
a subsequent transfer section disposed between said output tower and said at least one subsequent output tower, wherein a subsequent transfer belt is disposed within said subsequent transfer section, wherein said subsequent transfer belt is capable of receiving an item from said output tower, transferring, via said subsequent transfer belt of said subsequent transfer section, said received item to said subsequent output platform, and wherein a surface of said subsequent transfer belt maintains a desired axial or rotational position within said subsequent output tower.

16. The container transport and delivery system of claim 15, wherein said input tower extends substantially vertically.

17. The container transport and delivery system of claim 15, wherein said output tower extends substantially vertically.

18. The container transport and delivery system of claim 15, wherein said at least one subsequent output tower extends substantially vertically.

19. The container transport and delivery system of claim 15, further comprising an output belt disposed proximate said output window of said output tower and wherein said output platform is capable of transferring an item from said output platform to said output belt.

20. The container transport and delivery system of claim 15, further comprising a subsequent output belt disposed proximate said subsequent output window of said subsequent output tower and wherein said subsequent output platform is capable of transferring an item from said subsequent output platform to said subsequent output belt.
